(19) United States
(12) Patent Application Publication
(10) Pub. No.: US 2020/0291701 A1
(43) Pub. Date: Sep. 17, 2020

(54) DEVICE FOR SPACING AN OPENING ELEMENT APART FROM A STATIONARY ELEMENT, IN PARTICULAR OF A MOTOR VEHICLE

(71) Applicant: EXSTO THERMOPLASTICS, Romans Sur Isere (FR)

(72) Inventors: Stéphane PERCHE, Saint Bardoux (FR); Bertrand LEON, Tullins (FR)

(73) Assignee: EXSTO THERMOPLASTICS, Romans Sur Isere (FR)

(21) Appl. No.: 16/652,439

(22) PCT Filed: Oct. 4, 2018
(86) PCT No.: PCT/FR2018/052455

§ 371 Date: Mar. 31, 2020

(30) Foreign Application Priority Data
Oct. 19, 2017 (FR) 17/59825

(51) Int. Cl. E05C 21/00; B62D 65/02

(52) U.S. Cl. CPC E05C 21/005; B62D 65/06; B62D 65/026

(57) ABSTRACT

The present invention relates to a device (100) for holding an opening element in an ajar position on a stationary part of a body of a motor vehicle, comprising a spacing element (1) provided to be attached to a stationary part of the vehicle body or to the opening element, the spacing element (1) comprising a base (10) provided for attaching the spacing element (1) to the stationary part or to the opening element, characterized in that the spacing element (1) comprises: —a connecting member (30) attached to the base (10) and comprising an elastically deformable zone (32) designed to deform under the action of stresses exerted by a holding member presented by the opening element (200) or the stationary part, —a retaining member (40) attached to the connecting member (30) and comprising an elastically deformable zone (41) designed to deform under the action of stresses exerted by the holding member.

The object of the invention is a device for holding in a half-open position a door leaf on a fixed element of a body of a motor vehicle during its manufacture.

A motor vehicle is manufactured on a production line which performs a step of assembling elements, such as door leaf elements for example, on a vehicle body thus forming a complete vehicle bodywork.

A tolerance of a few millimeters, generally +1-2 mm, is accepted during this assembly. Thus, a relative position of an element with respect to another varies by a few millimeters from one vehicle to another.

It is known to use devices holding the door leaf elements in a half-open position with respect to the body element in order to allow in particular an easy opening and closing of the door leaf on the production line.

More particularly, the document WO2014170610 discloses a device including a retaining member intended to cooperate with a holding member, the retaining member being intended to be fixed on a portion of a door leaf element and a holding member on a fixed portion of a bodywork, or vice versa.

To put the door leaf element in the half-open position, the holding member comes into contact with a contact side of the retaining member. Then, the holding member exerts a closing force so as to elastically deform the retaining member and to come into contact with a side opposite to the contact side.

Conversely, to put the door leaf element in the open position, the holding member exerts an opening force so as to elastically deform the retaining member and no longer be retained by the retaining member.

The opening force is dependent on a geometry of the retaining member and a relative position of the retaining member with respect to the holding member.

Thus, the tolerance accepted during the assembly of the door leaf element with respect to the vehicle body causes a variation in the opening force to be applied between two vehicles or between two door leaf elements of the same vehicle.

The object of the invention is a device whose opening force is independent of a relative position of the door leaf element with respect to the vehicle body.

The invention relates to a device for holding in a half-open position a door leaf element on a fixed portion of a body of a motor vehicle, comprising a spacing element provided to be fixed on a fixed portion of the vehicle body or on the door leaf element, this spacing element comprising a base provided for a fixation of the spacing element on the fixed portion or on the door leaf,

characterized in that the spacing element comprises:
a connecting member attached to the base and including an elastically deformable zone designed to be deformed under the action of stresses exerted by a holding member presented by the door leaf element (200) or the fixed portion,
a retaining member attached to the connecting member and including an elastically deformable zone designed to be deformed under the action of stresses exerted by the holding member.

When the device is fixed on the fixed portion of the body, the holding member presented by the door leaf element, such as an edge or a ridge for example, cooperates with the spacing element so as to hold said door leaf element in a half-open position with respect to the fixed portion of the body.

Conversely, when the device is fixed on the door leaf element, the holding member presented by the fixed portion, such as an edge or a ridge for example, cooperates with the spacing element so as to hold said door leaf element in a half-open position with respect to the fixed portion of the body.

An open position is defined when the spacing element and the holding member do not cooperate, that is to say when they are not in contact with each other.

To put the door leaf element in a half-open position with respect to the vehicle body, an operator or a robot approaches the door leaf element of the body so as to put the holding member into contact with the retaining member. If the operator exerts a closing force greater than a predetermined closing force, the holding member elastically deforms the retaining member and the connecting member in a concomitant or successive manner. The door leaf element is then blocked in a half-open position.

An assembly of the door leaf elements with respect to the vehicle body is carried out with a certain tolerance. Thus, a relative position of the door leaf element with respect to the vehicle body, and therefore a relative position of the two elements of the device, vary according to the considered door leaf element.

The deformation of the elastically deformable zone of the connecting member by its contact with the holding member allows adapting the device to the relative position of the holding member. The elastically deformable zone of the connecting member is dimensioned to compensate for the deviation of the door leaf element with respect to the body of the vehicle, insofar as it is within the tolerance range.

Thus, the deformation of the connecting member positions the retaining member identically with respect to the holding member regardless of the initial position of the door leaf element with respect to the vehicle body from the moment when the possible offset is located within the tolerance range. The relative position of the retaining member with respect to the holding member is therefore made independent of the relative position of the two elements of the device.

To put the door leaf element in an open position with respect to the vehicle body, the operator exerts on the door leaf element an opening force greater than a predefined opening force so that the holding member elastically deforms the retaining member. The door leaf element is then in the open position.

Thus, thanks to the device according to the invention, the opening force to be exerted on the door leaf element to dislodge it from the retaining member is substantially identical regardless of the initial position of the door leaf element with respect to the vehicle body.

According to a characteristic of the invention, the elastically deformable zone of the connecting member is intended to allow the pivoting of the connecting member with respect to an axis of rotation.

According to a characteristic of the invention, the elastically deformable zone of the retaining member is intended to allow the pivoting of the retaining member with respect to an axis of rotation.

Thus, the connecting member and the retaining member are elastically deformable by pivoting.

According to a characteristic of the invention, the axis of rotation of the connecting member is parallel to the axis of rotation of the retaining member.

Thus, the deformation of the connecting member and the deformation of the retaining member are carried out in the same plane.

According to a characteristic of the invention, the retaining member is an elongation including a free end.

Thus, the retaining member comprises one free end and one end connected to the connecting member.

According to a characteristic of the invention, the retaining member has at least one protrusion at the free end.

Thus, the holding member is retained in the half-open position by the protrusion.

Preferably, the elastically deformable zone of the retaining member is positioned at an opposite end to the free end.

Thus, the elastically deformable zone of the retaining member attaches the retaining member to the connecting member.

According to another embodiment, the elastically deformable zone of the retaining member is substantially positioned in the middle of the elongation.

According to a characteristic of the invention, the connecting member is an elongation including a free end.

Thus, the connecting member comprises one free end and one end connected to the base.

According to a characteristic of the invention, the connecting member surrounds the retaining member.

According to a characteristic of the invention, the connecting member comprises at least one a stroke-end stop allowing to prevent the door leaf element from coming into a completely closed position on the vehicle body, or at least potentially up into contact with the vehicle body.

Preferably, the elastically deformable zone of the connecting member is positioned at an opposite end to the free end.

Thus, the elastically deformable zone of the connecting member attaches the connecting member to the base.

According to another embodiment, the elastically deformable zone of the connecting member is substantially positioned in the middle of the elongation.

According to one embodiment, the elastically deformable zone of the connecting member is designed so as to offer a resistance to the stresses exerted by the holding member presented by the fixed portion or the door leaf element different from that of the elastically deformable zone of the retaining member.

The invention will be better understood, thanks to the description hereinafter, which relates to one or several embodiments according to the present invention, provided as non-limiting examples and explained with reference to the appended schematic drawings, in which:

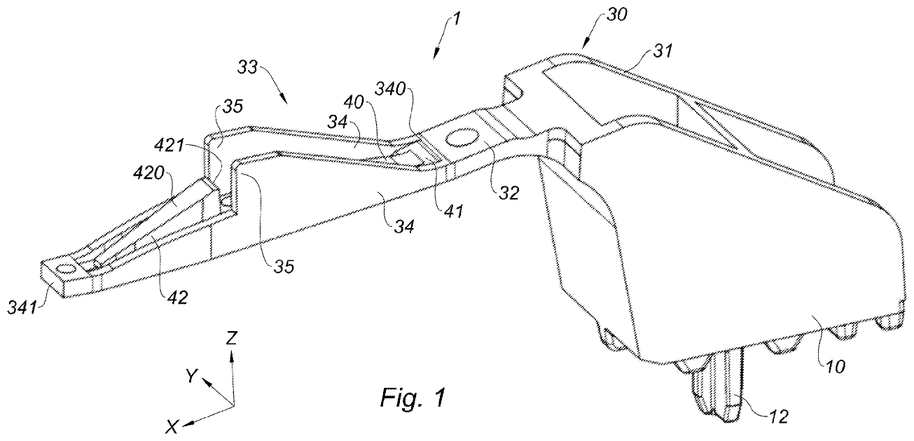

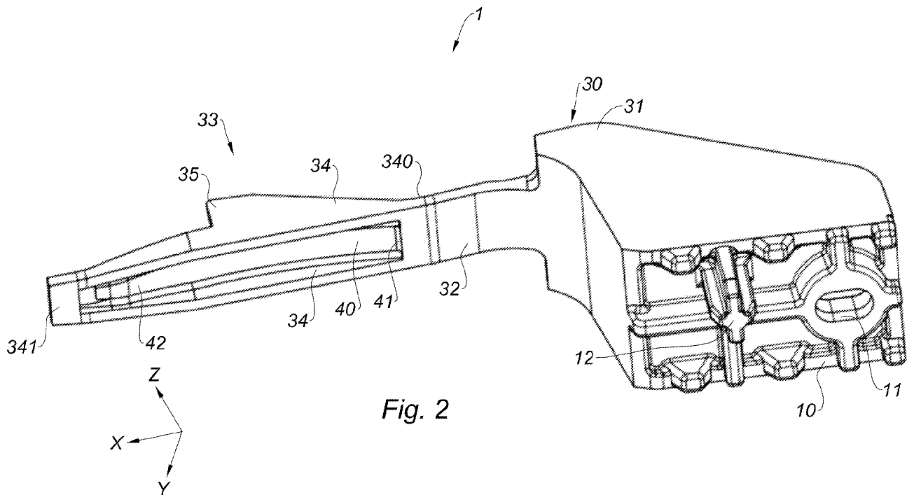

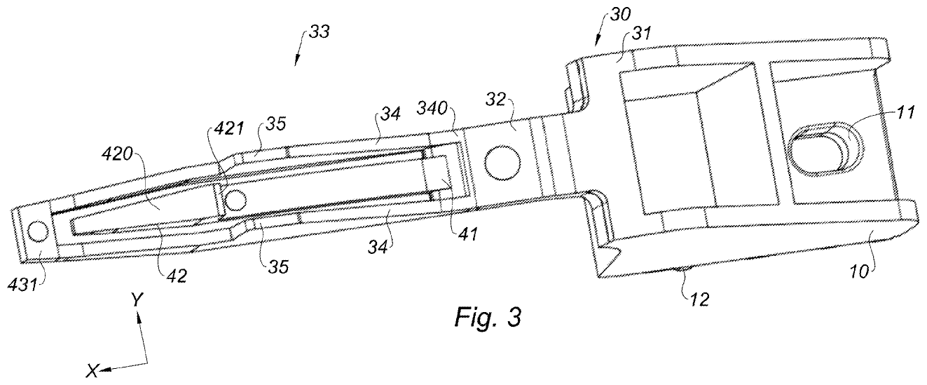

FIGS. 1 to 3 are perspective representations of a spacing element of a device according to the invention;

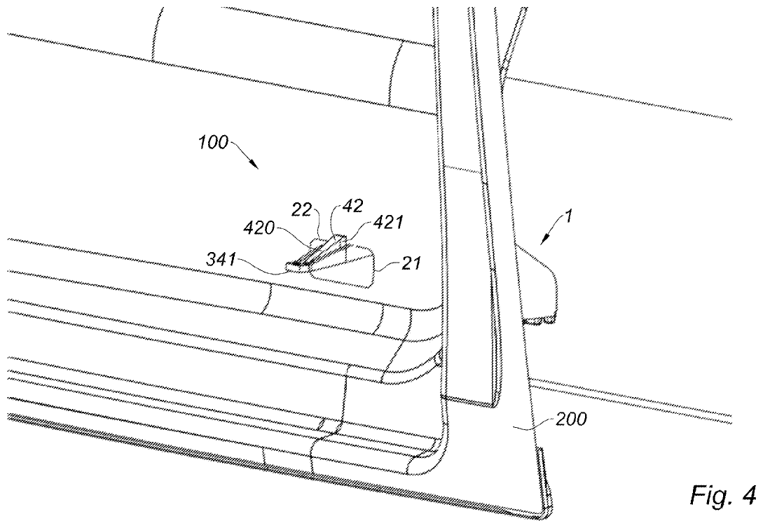

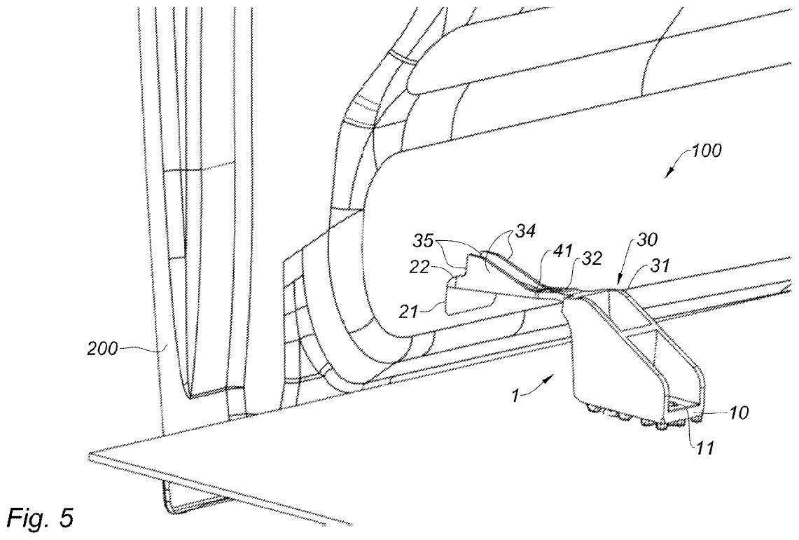

FIGS. 4 and 5 are schematic perspective representations of the spacing element according to the invention positioned on a motor vehicle.

FIGS. 1 to 3 represent perspective views of a spacing element 1 of a device 100 according to the invention. The spacing element 1 has a base 10 comprising an oblong orifice 11 for a fixing screw (not represented) and an elongated guide body 12. The base 10 is extended by a connecting member 30.

The connecting member 30 forms an elongation comprising a first portion 31 connecting the base 10 to an elastically deformable zone 32 and a second portion 33 extending the elastically deformable zone 32.

It is subsequently defined that an axis Z of the first element 1 of the device 100 is an axis transverse to an axis of elongation of the base 10.

It is subsequently defined that an axis X of the first element 1 of the device 100 is an axis of elongation of the second portion 33.

It is subsequently defined that an axis Y of the first element 1 of the device 100 is an axis perpendicular to the axes X and Z.

The elastically deformable zone 32 of the connecting member 30 has a thickness along the axis Z that is lower with respect to a length along the axis X, thus allowing a deformation of the connecting member by rotation along the axis Y.

The second portion 33 is an elongation formed by two symmetrical arms 34 connected by a first end 340 to the elastically deformable zone 32 and to a second end 341 therebetween. The second end 341 is a free end. The arms 34 define a space therebetween.

Each arm 34 comprises a stop 35 substantially positioned in the middle of the arm 34 and extending along the axis Z.

It, Each arm 34 has an arcuate shape between the second end 341 and the stop 35 so that a thickness of the arms 34 along the axis Z increases progressively from the second end 341 towards the stop 35.

The first end 340 of the arms 34 is connected to a retaining member 40 extending along the axis X. The retaining member 40 has an elongated shape provided with a first end and a second free end.

The first end of the retaining member 40 comprises an elastically deformable zone 41 whose thickness along the axis Z is small with respect to a length along the axis X, thus allowing a deformation of the retaining member 40 by rotation along the axis Y.

The free end of the retaining member 40 is provided with a protrusion 42. The protrusion 42 has a contact side 420 and a retaining surface 421.

The contact side 420 has a thickness along the axis Z which gradually increases from the free end to a center of the retaining member 40.

The retaining surface 421 is substantially perpendicular to the retaining member 40.

When the device 100 is installed on a vehicle as can be seen in FIGS. 4 and 5, an operator introduces the guide body 12 of the base 10 of the spacing element 1 into an orifice (not represented) of a fixed portion of a vehicle chassis. Then, the operator pivots the fixing screw so as to temporarily fix the spacing element 1 on the vehicle.

The door leaf element 200 has an orifice 21 with a substantially rectangular section provided to cooperate with the spacing element 1. This orifice 21 includes an edge 22 provided to act as a holding member in operation.

More specifically, when the operator approaches the door leaf element 200 to the vehicle chassis by exerting a closing force, the spacing element 1 of the device 100 is introduced into the orifice 21. The holding member 22 then comes into contact with the second end 341 of the second portion 33. Then the holding member 22 slides against the arcuate shape of each arm 34 so as to deform the second portion 33 at the level of the elastically deformable zone 32. The holding member 22 also slides against the contact side 420 of the retaining member 40, deforms the retaining member 40 at the level of the elastically deformable zone 41 and then comes into contact with the retaining surface 421.

Thus, the holding member 22 is blocked in a half-open position between the stops 35 of the connecting member 30 on the one hand, and the protrusion 42 of the retaining member 40 on the other hand.

The deformation of the connecting member 30 allows to adapt the device 100 to a relative position of the door leaf element 200 with respect to a fixed portion of the vehicle chassis.

The retaining member 40 is then in a reference position with respect to the holding member 22. The reference position is independent of the relative position of the door leaf element 200 with respect to a fixed portion of the vehicle chassis.

When the operator exerts an opening force having a predefined value, the holding member 22 deforms the retaining member 40 at the level of the elastically deformable zone 41 so as to release the holding member and to put the door leaf element 200 in an open position.

The retaining member 40 being in the reference position with respect to the holding member 22, the opening force to be exerted by the operator is predefined by the dimension along the axis Z of the retaining surface 421 and the stiffness of the elastically deformable zone 41.

The opening force is identical regardless of the relative position of the door leaf element 200 with respect to a fixed portion of the vehicle chassis.

Thus the opening force is determined at the design of the device 100 and is identical regardless of the vehicle or the door leaf on which the device 100 is positioned.

Of course, the invention is not limited to the embodiments described and represented in the appended figures. Modifications remain possible, in particular with regards to the constitution of the various elements or by substitution with technical equivalents, yet without departing from the scope of protection of the invention.

1. A device for holding in a half-open position a door leaf element on a fixed portion of a body of a motor vehicle, comprising a spacing element provided to be fixed on a fixed portion of the vehicle body or on the door leaf element, this spacing element comprising a base provided for a fixation of the spacing element on the fixed portion or on the door leaf element wherein the spacing element comprises:
a connecting member attached to the base and including an elastically deformable zone designed to be deformed under the action of stresses exerted by a holding member presented by the door leaf element or the fixed portion,
a retaining member attached to the connecting member and including an elastically deformable zone designed to be deformed under the action of stresses exerted by the holding member.

2. The holding device in the half-open position according to claim 1, wherein the elastically deformable zone of the connecting member is intended to allow the pivoting of the connecting member with respect to an axis of rotation.

3. The holding device in the half-open position according to claim 1, wherein the elastically deformable zone of the retaining member is intended to allow the pivoting of the retaining member with respect to an axis of rotation.

4. The holding device in the half-open position according to claim 2, wherein the axis of rotation of the connecting member is parallel to the axis of rotation of the retaining member.

5. The holding device in the half-open position according to claim 1, wherein the retaining member is an elongation including a free end.

6. The holding device in the half-open position according to claim 1, wherein the retaining member has at least one protrusion at the free end.

7. The holding device in the half-open position according to claim 5, wherein the elastically deformable zone of the retaining member is positioned at an opposite end to the free end.

8. The holding device in the half-open position according to claim 5, wherein the elastically deformable zone of the retaining member is positioned substantially in the middle of the elongation.

9. The holding device in the half-open position according to claim 1, wherein the connecting member is an elongation including a free end.

10. The holding device in the half-open position according to claim 1, wherein the connecting member comprises at least one stroke-end stop allowing to prevent the door leaf element to come into a completely closed position on the vehicle body.

11. The holding device in the half-open position according to claim 9, wherein the elastically deformable zone of the connecting member is positioned at an end opposite to the free end.

12. The holding device in the half-open position according to claim 9, wherein the elastically deformable zone of the connecting member is positioned substantially in the middle of the elongation.

13. The holding device in the half-open position according to claim 1, wherein the elastically deformable zone of the connecting member is designed so as to offer a resistance to the stresses exerted by the holding member presented by the fixed portion or the door leaf element different from the elastically deformable zone of the retaining member.
